(19) United States
(12) Patent Application Publication
(10) Pub. No.: US 2025/0217420 A1
(43) Pub. Date: Jul. 3, 2025

(54) SYSTEM AND METHOD FOR CENTRALIZED CRAWLING, EXTRACTION, ENRICHMENT, AND DISTRIBUTION

(71) Applicant: P39 Tech LLC, New York, NY (US)

(72) Inventors: Alex WHITE, New Rochelle, NY (US); Jonathan SCHLER, Petach Tikwa (IL)

(73) Assignee: P39 Tech LLC, New York, NY (US)

(21) Appl. No.: 18/398,978

(22) Filed: Dec. 28, 2023

(51) Int. Cl. G06F 16/951

(52) U.S. Cl. CPC G06F 16/951

(57) ABSTRACT

A system and method for centralized crawling and extracting data points of a webpage using a centralized crawler system is provided. The method includes crawling requested webpage data, wherein the requested webpage data is selected based on a plurality of rules and includes a hypertext markup language (HTML) layer and metadata of a requested webpage; extracting at least one data point that indicate a main element that describes contents of the requested webpage; generating at least one enriched data point that provides additional information on the at least one extracted data point, wherein the additional information is collected from a plurality of data analysis systems (DASs); and creating a structured dataset of the requested webpage data based on the at least one extracted data point.

### TECHNICAL FIELD

The present disclosure relates generally to web crawlers and, in particular, to systems and methods for centralized crawling for uniform distribution and flexible enrichment.

### BACKGROUND

As computers, smartphones, and other internet-equipped devices become increasingly common in daily life, personalized targeting of the users of such devices for enhanced services is a growing interest. Particularly, with the abundance of information and resources in the communication network, effectively reaching the user with personalized needs is crucial for service providers.

Certain solutions to identify relevant and/or valuable websites rely on tools such as crawlers that collect data from websites. The crawler collects data from the entire webpage, given website information, for example, a Uniform Resource Locator (URL) of the webpage, to create a database of the collected data for further analysis. To this end, an increasing number of crawlers are being introduced in the internet space for individual parties (e.g., retailers, service providers, etc.) to collect website information and create logical structures. However, developing such crawler systems requires significant investments in infrastructure to, for example, identify webpage, crawl data, extract data, and more, particularly, at large scale, volume, latency, webpage diversity, language diversity, and more. Moreover, connecting such crawlers to individual components such as, a publisher, content delivery network (CDN), and the like, are not readily attainable. Often, access to such platforms is unfavorable, if not impossible, to unknown crawlers and are limited to trustable crawlers in order to, for example, prevent safety risks.

In current implementations, some crawlers may directly connect to publishers (or web servers) to grab webpage data. However, continued increase in the number of individual crawlers can impose problems. As noted above, connection of unknown (or unauthorized) crawlers may increase security risks. Furthermore, crowdedness from multiple crawlers at the publisher platform may increase traffic congestion and load on webpages. In addition, implementation of multiple crawlers to grab data from a single webpage is complex in itself. It should be identified that low transmission rates from congestion can be particularly concerning in certain technology sectors, for example, but not limited to, digital advertising environments, and the like, that require decision making in real-time or near real-time, within a sufficiently short period of time (e.g., 10 milli-second).

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include a method for centralized crawling and extracting data points of a webpage using a centralized crawler system. The method comprises: crawling requested webpage data, wherein the requested webpage data is selected based on a plurality of rules and includes a hypertext markup language (HTML) layer and metadata of a requested webpage; extracting at least one data point that indicate a main element that describes contents of the requested webpage; generating at least one enriched data point that provides additional information on the at least one extracted data point, wherein the additional information is collected from a plurality of data analysis systems (DASs); and creating a structured dataset of the requested webpage data based on the at least one extracted data point.

Certain embodiments disclosed herein also include a non-transitory computer readable medium having stored thereon causing a processing circuitry to execute a process, the process comprising: crawling requested webpage data, wherein the requested webpage data is selected based on a plurality of rules and includes a hypertext markup language (HTML) layer and metadata of a requested webpage; extracting at least one data point that indicate a main element that describes contents of the requested webpage; generating at least one enriched data point that provides additional information on the at least one extracted data point, wherein the additional information is collected from a plurality of data analysis systems (DASs); and creating a structured dataset of the requested webpage data based on the at least one extracted data point.

Certain embodiments disclosed herein also include a system for centralized crawling and extracting data points of a webpage using a centralized crawler system. The system comprises: a processing circuitry; and a memory, the memory containing instructions that, when executed by the processing circuitry, configure the system to: crawl requested webpage data, wherein the requested webpage data is selected based on a plurality of rules and includes a hypertext markup language (HTML) layer and metadata of a requested webpage; extract at least one data point that indicate a main element that describes contents of the requested webpage; generate at least one enriched data point that provides additional information on the at least one extracted data point, wherein the additional information is collected from a plurality of data analysis systems (DASs); and create a structured dataset of the requested webpage data based on the at least one extracted data point.

Certain embodiments disclosed herein include the method, non-transitory computer readable medium, or system noted above, further including or being configured to perform the following steps: providing the at least one enriched data point of the webpage to an external entity.

Certain embodiments disclosed herein include the method, non-transitory computer readable medium, or system noted above, further including or being configured to perform the following steps: distributing a subset of the at least one extracted data point to a first DAS of the plurality of DASs, wherein the subset of the at least one extracted data point is determined based on a first filtering rule of the first DAS; and causing generation of the additional information on the subset of the at least one extracted data point.

Certain embodiments disclosed herein include the method, non-transitory computer readable medium, or system noted above, further including or being configured to perform the following steps: storing a cache for the requested webpage, wherein the cache includes at least one of: the webpage data, the at least one extracted data point, at least one attribute, the at least one enriched data point, and the structured dataset.

Certain embodiments disclosed herein include the method, non-transitory computer readable medium, or system noted above, wherein the attribute is at least one of: content type, topic, language, sentiment, safety information, and domain information.

Certain embodiments disclosed herein include the method, non-transitory computer readable medium, or system noted above, further including or being configured to perform the following steps: subsequently selecting to request the requested webpage data; and retrieving portions of the structured dataset from the cache.

Certain embodiments disclosed herein include the method, non-transitory computer readable medium, or system noted above, further including or being configured to perform the following steps: distributing a second subset of the at least one extracted data point to a second DAS of the plurality of DASs, wherein the second subset of the at least one extracted data point is determined based on a second filtering rule of the second DAS; and generating at least one second enriched data point collected from the second DAS, wherein the second DAS is caused to generate the at least one second enriched data point; and adding the at least one second enriched data point to the structured dataset and the cache of the requested webpage.

Certain embodiments disclosed herein include the method, non-transitory computer readable medium, or system noted above, wherein the plurality of rules is defined by at least one of: a user demand, a web server, each DAS of the plurality of DASs, a schedule, a domain, and a network traffic.

Certain embodiments disclosed herein include the method, non-transitory computer readable medium, or system noted above, further including or being configured to perform the following steps: identifying contents of the requested webpage from the crawled webpage data; applying an algorithm to identify at least one main element and at least one attribute, wherein the at least one main element is identified as the at least one extracted data point; and generating the at least one attribute by classifying the at least one main element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart depicting a method for centralized crawling and distribution of webpage data according to an embodiment.

FIG. 3 is a flowchart depicting a method for centralized processing of crawled data according to one embodiment.

FIG. 4 is a flow diagram illustrating a process of distributing enriched data points of a webpage by a centralized crawler system (CCS) according to one example embodiment.

FIG. 5 is a schematic diagram of a centralized crawler system (CCS) according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments provide a system and method for centralized crawling of webpage data using a common centralized crawler system (CCS). The CCS is configured with a universal crawler that grabs data from a webpage and uniformly distributes crawled data to multiple entities, concurrently. The multiple entities may include any device, system, or the like, that may benefit from such crawled data from the webpage. The disclosed embodiments further process the crawled data to extract data points indicating the main elements and generate attributes, based on contextual, audio/video content, structural content, domain content, and more, that are analyzed through at least one algorithm to share the main elements with the multiple entities. It should be noted that centralized crawling and distribution of processed crawled data improves communication and computing efficiencies within the communication network (e.g., the Internet).

It has been identified that connections of multiple crawlers at the web servers create problems of network traffic congestion and resource drain in various components connected over the network and particularly at the web server. To this end, in the disclosed embodiments, the centralized crawler system (CCS) is implemented to replace the multiple crawlers. The CCS's ability to uniformly distribute crawled and/or processed data enables democratization of data to all entities without having themselves directly connecting. In addition to reducing traffic and computing strain, security threats may be also reduced in that fewer unknown servers may access the webpage. It should be noted that reducing traffic for rapid transmission of data is particularly beneficial for efficient updating of data points for webpages and maintaining an up-to-date CCS and/or database.

The disclosed embodiments provide an advantageous method to process and generate structured datasets of extracted data points and attributes with respect to each of the webpages. To this end, the system disclosed herein not only provides a wholistic representation of the large web-space in the network, but with improved efficiency by preventing uncontrolled crawling and accumulation of data (e.g., irrelevant webpages, headers, etc.) that may strain the computational resources.

Moreover, centralized sharing of processed data enables open and flexible enrichment at, for example, external data analysis systems, that may freely analyze the shared data using their respective services and algorithms. The external data analysis system that may receive processed data for further analysis is not restricted and may be expanded, thereby enabling scalability and wide range of enrichment. In addition, the disclosed embodiments allow selective sharing of processed data by sending portions of the extracted data to the data analysis systems. The portions of the processed data may be determined at the CCS prior to sending in order to provide relevant data at sufficient capacity and/or rate rather than blind transmission of all data. It should be noted that such centralized, yet selective sharing of processed data enables effective enrichment while reducing the network traffic and burden on the CCS as well as the external data analysis systems. The disclosed embodiments that utilize a CCS provide advantageous collection, processing, and transmission of webpage information, thereby enabling improvements in scalability, latency, diversity, and the like.

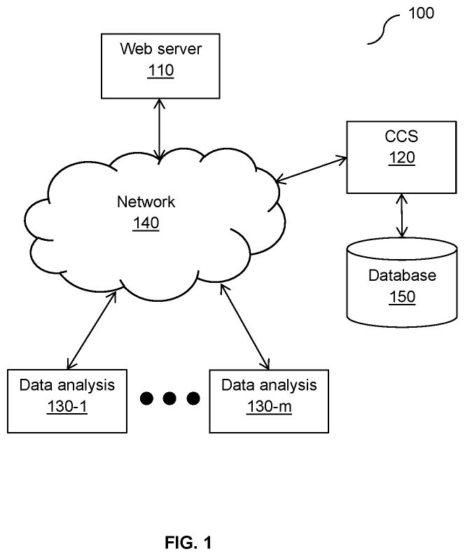

FIG. 1 is an example network diagram depicting a network system 100 utilized to describe the various disclosed embodiments for collecting and processing data using a centralized crawler system (CCS). The depicted network diagram 100 includes a web server 110, a centralized crawler system (CCS) 120, multiple data analysis systems (DAS) 130-1 through 130-m (hereinafter referred as data analysis system (DAS) 130 or data analysis systems (DASs) 130, where m is an integer greater than 1), and a database 150. In an embodiment, the CCS 120 includes a cache memory and a universal crawler engine (not shown).

It may be understood that the components and configuration described with respect to FIG. 1 are so provided for purposes of illustration and that other, like components, and combinations or configurations thereof, may be likewise applicable to the embodiments disclosed herein without loss of generality or departure from the scope of the disclosure.

The various components discussed with reference to FIG. 1 are connected through a network 140. Such networks may include, as examples and without limitation, wireless, cellular, or wired networks, local area networks (LANs), wide area networks (WANs), metro area networks (MANs), the Internet, the worldwide web (WWW), similar networks, and any combination thereof. The network 140 may be a full-physical network, including exclusively physical hardware, a fully-virtual network, including only simulated or otherwise virtualized components, or a hybrid physical-virtual network, including both physical and virtualized components. Further, the network 140 may be configured to encrypt data, both at rest and in motion, and to transmit encrypted, unencrypted, or partially-encrypted data.

The network 140 may be configured to connect to the various components of the system via wireless means such as Bluetooth (tm), long-term evolution (LTE), Wi-Fi, other, like, wireless means, and any combination thereof, via wired means such as, as examples and without limitation, Ethernet, universal serial bus (USB), other, like, wired means, and any combination thereof. Further, the network 140 may be configured to connect with the various components of the system via any combination of wired and wireless means.

The web server 110 is a web server, a content delivery network (CDN), or the like, configured to provide website visitors with website content. The web server 110 may be implemented as a physical device, a system, a component, or the like, as a virtual device, system, component, or the like, or in a hybrid physical-virtual implementation. The web server 110 may communicate with the centralized crawler system (CCS) 120 that is connected to the web server 110 over the network 140. In an embodiment, the CCS 120 may be configured to get data from the web server 110 by crawling or like. In some embodiments, the CCS 120 may integrate to the web server 110 via an application programming interface (API).

The web server 110 may be configured to respond to a user's website access request by serving webpages (or other content) to the user device (not shown). Webpages (also referred to as pages) are typically processed and displayed over web browsers or mobile applications (apps). The served webpages may include various content such as, but not limited to, texts, images, hyperlinks, video, audio, other multimedia, and the like, and any combination thereof.

The centralized crawler system (CCS) 120 is a device, component, system, or the like, configured to provide dynamic processing and distribution of crawled data to multiple entities. In an embodiment, the CCS 120 reads the traffic, for example user access request, in the network and/or the web server 110, to collect, analyze, and distribute information about the webpage.

The CCS 120 may be a standalone system or may be integrated to other components, device, system, or the like that communicate over the network 140. For simplicity, a single CCS 120 is described in FIG. 1, however it should be understood that more than one CCS 120 may be configured to perform methods described herewith. The one or more CCS 120 may operate in parallel for added scalability and processing efficiency.

The CCS 120 may be integrated to a device, component, system, or the like, through an application programming interface (API), to access and read incoming traffics, as well as to write extracted data points. According to the embodiments disclosed herein, the CCS 120 includes a universal crawler engine (not shown) that collects webpage data from a set of web servers 110. In an embodiment, the crawler engine grabs data from relevant webpages in semi real-time, based on continuous reading of the traffic. In a further embodiment, the webpage data is collected based on triggers from one or more rules from, for example, but not limited to data analysis systems (DASs) 130, the publisher (of the web server 110, not shown), and the like, and any combination thereof. The plurality of rules for requesting and grabbing webpage data may be defined based on, for example, but not limited to, user demand, web server 110, DAS 130, schedule, webpage relations, domains, traffic, and the like, and any combination thereof. The crawled data may be collected from, for example and without limitation, periodic crawling of app pages, scraping for app data, grabbing from webpages in a list of domains, and more.

For example, the universal crawler engine of the CCS 120 grabs data from the sports news website when a user requests access to the sports news website. It should be noted that collecting webpage data based on the plurality of rules prevents meaningless and continuous crawling of data, thereby conserving computing resources in memory and processing power. That is, triggered crawling of selected webpage data eliminates accumulation of irrelevant webpage data to take up storage, for example, in the database 150.

It should be noted the universal crawler engine is not confined to a particular entity, for example, a third-party system, a publisher, or the like, and thus, the universal crawler engine grabs webpage data that may be uniformly provided to multiple entities, for example, but not limited to, one or more DASs 130, edge-user device, other data consumers, and the like, and any combination thereof. To this end, the universal crawler engine may replace plurality of individual crawlers accessing the publisher to reduce traffic and use of resources at these components as well as in the overall network. It should be appreciated that the universal crawler engine connected to a publisher enables improved security by limiting the number of crawler systems directly connecting to these components, thereby reducing likelihood of attacks, for example without limitation, denial-of-service (DDOS) attacks. The CCS 120 may communicate with the various DASs 130 and the web server 110, directly, though the network 140 acting as a middle proxy for these components with the capability to uniformly provide webpage data.

According to the disclosed embodiments, the CCS 120 is further configured to apply at least one algorithm, such as a machine learning algorithm, to the crawled data and/or extract data points in order to determine attributes for the respective webpage of the crawled data. The crawled data are used herein to indicate webpage data that may be obtained, for example and without limitation, by crawling, from a cache memory, the database 150, and more. The crawled data of a webpage is a document that includes one or more data features and is in the web server 110.

An attribute is a characteristic feature, often a content feature, that describes the webpage, but may not be directly visible from the content and/or raw hypertext markup language (HTML) data of the webpage. In an embodiment, the attribute may include, but is not limited to, content type, topic, language, sentiment, safety information, domain information, and the like, and any combination thereof. In an embodiment, the different layers of crawled data such as, but not limited to HTML layer, visual layer, content layer, and the like, and associated metadata are input into a machine learning model to extract data points that indicate important and main elements of the webpage. In a further embodiment, such extracted data points are used as inputs for, for example, multilayer classification that identifies and outputs one or more attributes of the webpage. The extracted data points and identified attributes for the respective webpage may be modeled into structured datasets and stored in a memory and/or a database 150. The database 150 may be part of, externally connected, or both, relative to (e.g., over a network 140) the CCS 120.

It has been identified that conventional crawlers gather data from the entire website and/or webpages regardless of the main elements, context, or data of concern to cause burden on computing resources both at the CCS 120 and at the receiving entities, such as the data analysis systems 130, of the crawled data. However, the at least one algorithm configured according to the disclosed embodiments enables identification and storage of main elements and attributes of the webpage to reduce memory and/or storage use at the CCS 120 and the DAS 130. The main element may include URL parameters (or identifiers) that define the webpage, Moreover, structured datasets including the one or more main elements allow efficient discovery of relevant webpages for further processing, thereby further reducing processing power and speed at the CCS 120. It should be further noted that transfer of structured datasets, excluding non-essential webpage data, allows efficient communication over smaller bandwidths.

According to the disclosed embodiments, at least portions of the extracted data points and determined attributes are sent to data analysis systems (DASs) 130 for additional information on the extracted data points. The extracted data points may include content portions of the webpage, for example, but not limited to, text, image, multimedia, and the like, and any combination thereof. As an example, the DAS 130 may receive images of cats to determine color, breed, and the like of the cat as well as location of cat on the webpage, and more. The portions of extracted data points and attributes to send may differ between the DASs depending on, for example, a plurality of filtering rules defined by the DAS, publisher policy, and the like. In some embodiments, the publisher policy defined by the publisher (of the web server 110) employed at the CCS 120 allows publisher control over portions of data points and attributes distributed to particular DASs 130. In an example embodiment, the communication between CCS 120 and DASs 130 may be near real-time upon detecting relevant webpages in the traffic. In another example embodiment, extracted data points and attributes collected at the CCS 120 may be sent intermittently or upon specific query from the DAS 130 to receive extracted data points for batches of relevant webpages collected over time. Such queries or requests may be submitted through API exposed by a DAS 130 or by the CCS 120.

The data analysis systems (DASs) 130 are systems, components, devices, or the like, configured to provide one or more enriched data points to the extracted data points received, together with the attributes, from the CCS 120. The DASs 130 may include, as examples and without limitation, image recognition services configured to return image enriched data points based on image data, text analysis services, video analysis services, metadata analysis services, and the like, and any combination thereof. The enriched data points to the received extracted data points and attributes provide additional data points that are not generated at the CCS 120.

As an example, an image recognition DAS receives image data of all athletes on a sports news website. The DAS processes these images to identify the identities of each athlete in the images and adds enriched data points to each of the image data. The enriched data points are returned back to the CCS 120 for additional details on the webpage and may be utilized for further processing. Such enriched data points may be stored in a memory and/or database 150 associated with the CCS 120. The DASs 130 may be various systems, or the like, provided by one or more hosts, vendors, or the like, where such DASs 130 may be configured to operate as described herein. Further, the DASs 130 may be operated by third-party companies.

The database 150 may include at least the webpage data and may further include, for example, but not limited to, extracted data points, attributes, enriched data points, and the like for each respective webpage data, and more, for a plurality of webpages. It should be noted that continuous crawling and analysis using the CCS 120 may provide webpage data to encompass the entire web space. In an embodiment, the webpage data and associated extracted data points, attributes, enriched data points, and the like are stored and retrieved using main elements (or URL parameters) that define the content of the webpage. To this end, the webpage data and associated additional data may be rapidly and sophisticatedly discovered through matching of relevant data that describe the content of the webpage. For example, rather than matching using text in the header, matching and discovery will be performed by analyzing the main text of the webpage.

In an embodiment, at least portions of the webpage data stored in the database 150 may be stored in a cache memory. The portions of webpage data to store in the cache memory may be determined at any point during the centralized crawling, processing, and distribution of the webpage data, and further stored at any such point. In some implementations, the webpage data (e.g., crawled data, extracted data, attributes, enriched data, etc.) to store in the cache memory may be predetermined.

It may be understood that the various components of the network system described with respect to FIG. 1 may be separately implemented, including in multiple, separate locations, and may be interconnected via one or more networks.

As an example of an alternate configuration, applicable to a mobile application (app) installed on a smartphone, the web server 110 may be replaced with an application content delivery network (CDN), wherein the application CDN is configured to provide and execute those functionalities, with respect to an application installed on a smartphone, which may be similarly provided by the web server 110. The example alternate configuration provides for the collection of app data, based on a user's interaction with the smartphone application, and processing of such app data as described herein. That is, the disclosed embodiments are applicable to any type of user device and any type of application.

It should be noted that the process performed by the CCS 120 to enrich webpage data may be performed without storing any cookies, or other data structure, in the user device from which user access request is received.

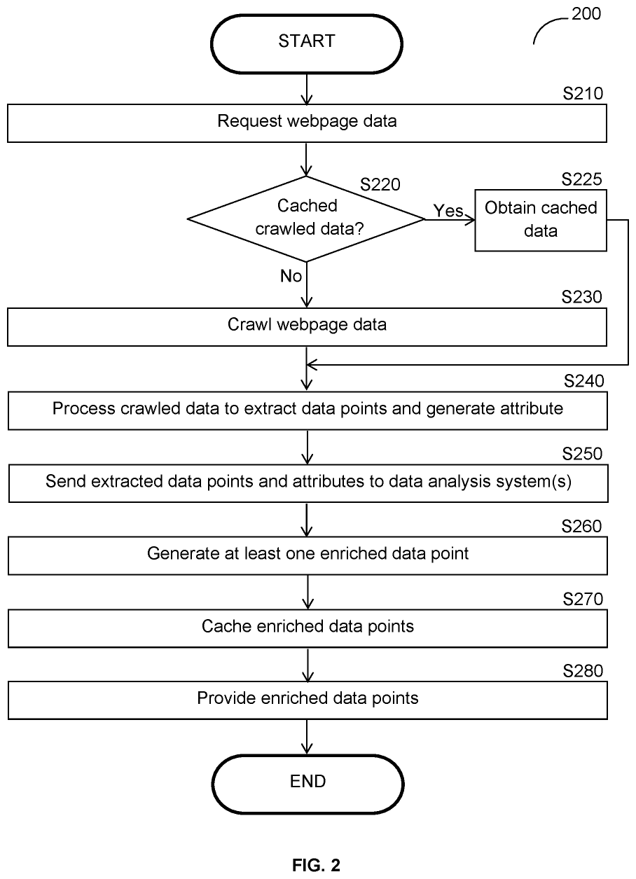

FIG. 2 is an example flowchart 200 illustrating a method for centralized crawling and distribution of webpage data according to an embodiment. The method described herein may be executed by the centralized crawler system (CCS) 120, FIG. 1. It should be noted that the method is described for a single request for a webpage, but the process may be simultaneously performed for a plurality of requests and a plurality of webpages.

The method of FIG. 2 is described herein with respect to webpages for illustrative purposes and simplicity, and other, like, implementations, in mobile phones or smart device applications, or the like, may be similarly applicable without loss of generality, or departure from the scope of the disclosure.

At S210, webpage data are requested. The webpage data includes data features including one or more descriptors relevant to the webpage and are provided by a publisher (or web server 110, FIG. 1). In an embodiment, the webpage data to request is selected from at least one webpage that is read from traffic communicated over the network (e.g., the network 140, FIG. 1). In some embodiments, the webpage data to request may be randomly selected from the many webpages of a web server (e.g., the web server 110, FIG. 1).

In an embodiment, the webpage data to request is selected based on a plurality of rules set by, for example, but not limited to, CCS, publishers (or web server), each of the data analysis systems (DASs), at least one end-user, and the like, and any combination thereof. Such plurality of rules may include, for example, but not limited to, external demands (e.g., from user, web server, DAS, and more), URL analysis, schedule, relationship between webpages, domain type, webpage traffic, triggers, and the like, and any combination thereof. In an embodiment, the plurality of rules for selection of webpage data to request may be determined and modified based on at least one algorithm, such as a machine learning algorithm. The plurality of rules may differ between webpages and may change over time. The triggers for requesting webpage data may be received from, for example, but not limited to, the DASs, at least one end-user, external entity, and the like, and any combination thereof, via an application programming interface (API), which may be initiated by, for example and without limitation, the machine learning algorithm, a cache refresh policy, and the like, and any combination thereof. In a further embodiment, the plurality of rules for selection may be updated based on real-time traffic read that the CCS reads through integration with, for example, but not limited to, a server, exchange, platform (e.g., demand-side platform in digital advertising), and the like, and any combination thereof.

In an example embodiment, the amount of traffic at the webpage and/or the associated domain may be used to determine the webpage to request. As an example, a webpage with high amount of traffic may be selected over a low traffic webpage, which may allow selecting of more popular and/or visited webpages. In another example embodiment, a list of webpages and/or domains may be provided by an external entity (e.g., DAS, web server, digital advertising companies, and more) which is used as one of the plurality of rules for selection. As an example, the list of webpages and/or domain includes the most popular website. In yet another example embodiment, a hybrid mode may be configured to select webpage of surrounding and/or sister webpages that are related to a webpage selected to be requested. It should be noted that selection of webpage data to request based on the plurality of rules enables selective requesting, and furthermore crawling, of relevant webpages and eliminates unnecessary and/or redundant webpages to be crawled at the CCS. Such selective requesting and crawling reduce the data transmittance, which in return conserves computer memory and processing power.

At S220, a check is performed whether there are cached crawled data associated with the requested webpage. If so, at S225, cached crawled data of the webpage are obtained from the cache and execution continues with S240. If not, execution continues with S230. The cached crawled data is the webpage data for the requested webpage data which may be, for example, previously crawled, recently crawled, or the like, and stored in a memory and/or a database (e.g., the database 150, FIG. 1).

A look up of webpage data in the cache may utilize URL parameters (or identifiers) that define the webpage. In an embodiment, the URL parameter for the webpage are generated by applying at least one algorithm, such as a machine learning algorithm, that identifies mandatory and/or optional parameters of the URL for recognizing the webpage. The generated URL parameter includes mandatory parameters that define the webpage and excludes parameters or portions of the URL string that do not add to defining the webpage (e.g., tracking parameters, etc.). It should be appreciated that checking for webpage data using the generated URL parameters allows efficient discovery of relevant webpage data, which may have been crawled from the webpage, for example, in a different format, login, and differed in the URL string.

In an embodiment, the execution may continue with S230 based on a refresh policy of the cache. The refresh policy includes a plurality of rules to trigger crawling of the webpage data to refresh the cache with respect to the webpage. The plurality of rules determine frequency and/or timing, identify duplicate webpages, and the like, and more, based on at least one algorithm such as a machine learning algorithm to tailor for the webpage (e.g., domain, URL, etc.). In an embodiment, the refresh policy is updated through a learning phase and/or concurrent learning with usage to enable adaptive caching. It should be noted that execution of S230, to crawl webpage data from the requested webpage, may be performed even when cached crawled data exists in the cache based on its refresh policy. The refresh policy may also trigger a request for webpage data (S210), which leads to crawling of webpage data. The refresh policy enables the CCS (e.g., the CCS 120, FIG. 1) to store “fresh” webpage data that is current in the rapidly changing digital environment. It should be further noted that the adaptive refresh policy of the cache enables efficient refreshing and crawling of webpage data that reduces cache memory and processing.

In an example embodiment, the frequency for refreshing cached data (i.e., crawling of webpage data) may be different between webpage and/or domains. As an example, the frequency, or time interval, of crawling data is shorter in a broadcasting webpage than a personal blog based on the rate of content update on the respective webpages. That is, adaptive frequencies may be implemented for efficient collection which enables up-to-date data collection without redundant collection of similar content. In another example embodiment, a cleaning algorithm may be applied to identify identical webpages to prevent duplicated crawling. As an example, a webpage has different URL strings depending on, for example, session, user identification (ID), cookie, and the like, and any combination thereof. The cleaning algorithm identifies that the different URL strings are associated with the same webpage and thus, crawling is not performed for the identical webpages with different URL strings.

In some implementations, at S220, a check is performed for one or more of cached extracted data points, attributes, and crawled webpage data. The extracted data points, as well as associated attributes, may be stored from the precedent crawling and processing of the webpage data, without storing the crawled webpage data. In such a scenario, the cached extracted data points may be obtained from the cache, and the operation may continue with S250. The check may also be performed for one or more enriched data points and associated data that were stored from previous operations (e.g., the method as described in FIG. 2). Such cached enriched data points may be obtained from the cache and/or storage, and the operation may continue with S280. The look up of the extracted data points and attributes utilizes the URL parameters (or identifiers) as noted above. In an example embodiment, the cache may include crawled webpage data, extracted data points, attributes, enriched data points, and the like.

At S230, webpage data are crawled from the webpage. The data descriptors received from the webpage are used to access and crawl webpage data. The crawled data includes various layers of data including, but not limited to, a HTML layer (HTML tags, neighbor tags, HTML tree structure, etc.), a visual layer (size, font, location of elements, etc.), a content layer (structure of text, textual clues, menu, etc.), and more, and any combination thereof as well as metadata (e.g., type of page, hierarchical position, domain, language, and more).

It should be noted that crawling by an authorized CCS allows the publisher control over the number and identity of entities that access its web server (e.g., the web server 110, FIG. 1). It should be further noted that the CCS may replace other, multiple crawlers from accessing webpage by functioning as the universal crawler that can grab and uniformly distribute webpage data to multiple entities, thereby reducing security risks and computing resources. In an embodiment, the crawled webpage data are stored in a memory and/or a database (e.g., the database 150, FIG. 1). In a further embodiment, the crawled webpage data are being stored in a cache memory.

At S240, the crawled data is processed to extract data points and generate attributes for the webpage. The crawled data are webpage data of the requested webpage including, for example, but not limited to, crawled webpage data (e.g., from S230), cached crawled data (e.g., from S225), and the like, any combination thereof. Processing of crawled data includes applying an algorithm to identify contents, style, and the like information and determine the main elements of the webpage. The crawled data is utilized to identify available content such as, but not limited to, text, hyperlinks, image, multimedia (e.g., video, audio, etc.) and the like, on the webpage.

The extracted data points may include, for example, but not limited to, text, images, videos, webpage structure, and the like, and any combination thereof, that are representative of the respective webpage. At least one model, such as a trained machine learning model is applied to the extracted data points to generate attributes such as, but not limited to, language, topics, sentiments, domain info, brand safety and suitability, and the like, and any combination thereof. The attributes represent characteristics of the webpage that may not be immediately apparent on the webpage and are not otherwise retrieved from the webpage data.

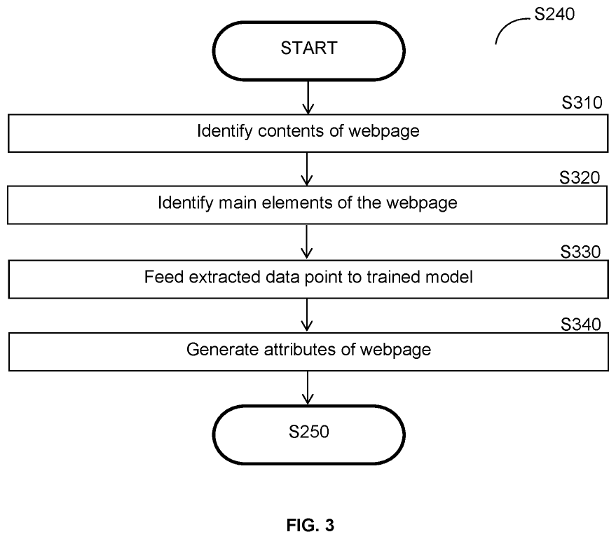

At least one algorithm such as a machine learning algorithm is applied to the webpage data (e.g., crawled, cached, etc.) to extract data points. In some embodiments, the extracted data points may be used as feedback data to train the model further. In some other embodiments, the extracted data points are cached. In some example embodiments, the model may be realized using a neural network, a deep neural network, and the like, programmed to run, for example, supervised learning. The processing of crawled data is further described below in FIG. 3 for one embodiment. In an embodiment, processing of crawled data to extract data points and generate attributes enables identification of webpage content and context. In a further embodiment, such processing removes webpage data are unrelated to the content and context such as, but not limited to, disclosure statements, headers, trackers, and the like, and any combination thereof, to generate concise structured datasets of relevant information for the respective webpage and use in future processes.

The extracted data points and attributes are cached in association to the webpage with a key, association, index, or other, like, data features, where the data feature is configured to provide for in-cache location of various extracted data points according to the values of the stored data features, such as in a cache search process. In an embodiment, the extracted data points and attributes for each webpage may be stored in a memory and/or a database (e.g., the database 150, FIG. 1). The extracted data points and/or attributes to store may be selective based on a predefined rule. It should be noted that the database includes aggregated data of a wide range of web servers in the concise structured datasets to represent the entire web space. In an embodiment, the extracted data points and attributes may be retrieved from the cache for subsequent request of a respective webpage. In such a scenario, the processing for extracted data points and attributes may be omitted to eliminate repetitive processing of the respective webpage and further conserve computing resources.

As noted above, the extracted data points and attributes are processed and stored as a structured data including the relevant information of the webpage. In a further example embodiment, the cached data for the webpage include identifiers that define the webpage and may exclude parameters or tags that do not add to defining the webpage, for example, tracking parameters, and the like that facilitate discovery of the cached webpage data. Thus, retrieval of cached data is based on data and parameters that describe the actual webpage, which in return improves accuracy and efficiency in storage, retrieval, and processing of the system. In some implementations, such a processing step may be omitted when cached extracted data point and/or attributes are available and obtained, as noted above.

At S250, the extracted data points and generated attributes are sent to one or more data analysis systems (DASs) (e.g., DASs 130, FIG. 1). The extracted data points and attributes, which may be newly extracted through processing at S240, retrieved from the cache memory or a database, and the like, and any combination thereof, are uniformly and simultaneously distributed to the one or more data analysis systems (DASs). The DAS, as described with respect to FIG. 1, is caused to generate and provide additional information to the extracted data points which may include, for example, but not limited to, text, image, video, audio, metadata, and the like, and any combination thereof. As noted above the extracted data points include main elements of the website identified based on analysis of content, context, and the like, of the webpage. The DAS may include, but is not limited to, image recognition services, text analysis services, video analysis services, metadata analysis services, and the like, and any combination thereof. It should be appreciated that the centralized crawling, processing, and distribution by the CCS allows democratization of webpage data from one crawler to multiple DASs for varied analysis without creating high traffic within the communication network.

In an embodiment, the extracted data points and attributes determined at the CCS may be filtered based on rules defined by each of the one or more DASs prior to sending to the respective DAS. The filtering rules defined by, for example, types of data points, attributes, communication rate or frequency, metadata of the webpage, and the like, and any combination thereof, allow each DAS to selectively receive data points of relevant webpages and relevant data points from the selected relevant webpages. Each DAS defines the filtering rules based on its, for example, processing capacity, type or service, and more. In an example embodiment, a DAS filters out webpages that include non-elected attributes and does not receive extracted data points and/or attributes of such subsets. As an example, a text analysis DAS with filtering rules of 10 request/minute, English language, and brand safe environment will only receive extracted data points and attributes processed at the CCS of web pages that are identified to be in English and on brand safe webpages at a rate of 10 request/minute. As another example, a DAS with filtering rules of 10% of traffic and images of animals, will receive extracted images of animals and their attributes of 10% of webpages crawled and processed at the CCS. In another embodiment, a sample subset that includes extracted data and attributes for randomly selected webpages (or URLs) is sent to the DAS for additional data.

At S260, additional information is collected from the DASs to generate enriched data points for the extracted data points. The enriched data points include additional data points related to the extracted data points that are stored together as a structured dataset. For example, if an extracted data point is an image, the enriched data point may be a description of the image (e.g., cats). As another example, if the extracted data point is a text, enriched data point may be demographics of the population that may be interested in such as text (e.g., political left-wing voters). In an embodiment, each of the DASs may apply its own model on the universally accessible extracted data points and attributes that are generated at the CCS. In a further embodiment, each of the DASs may provide different enriched data points by applying their own model on the commonly distributed extracted data points and attributes for various additional information on the webpage. It should be noted that the enriched data points added to the extracted data points are not restricted to a particular type to allow flexibility to the enrichment.

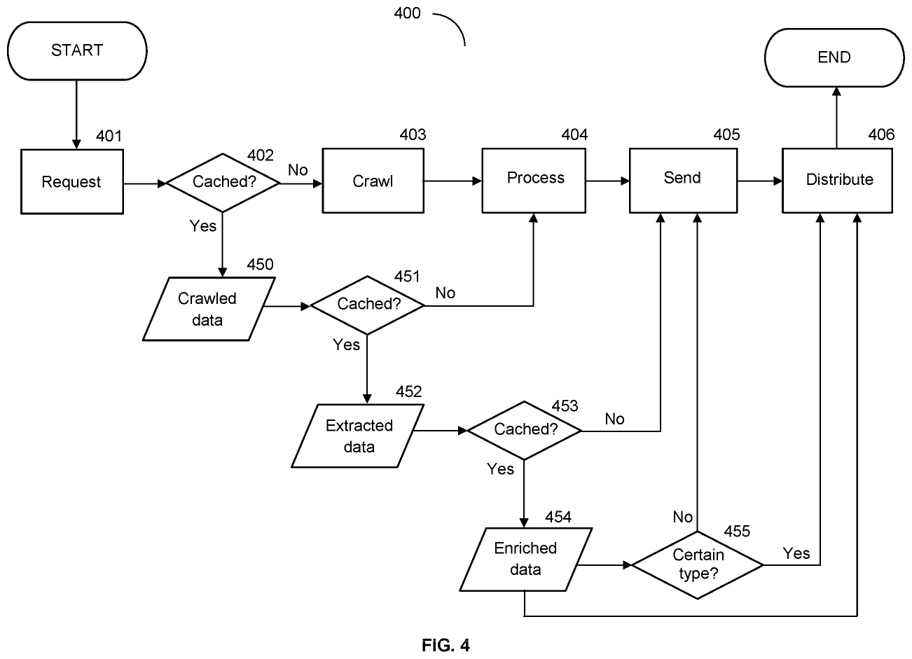

At S270, the enriched data points are cached in association with the corresponding extracted data points and/or attributes for the respective webpage. The cached enriched data points may be searched for and retrieved based on extracted data points for subsequent requests for the corresponding webpage. In some embodiments, cached enriched data points of various types, for example, but not limited to content, text, image, and the like, and any combination thereof, may be retrieved from the cache. In such scenarios, the steps of sending extracted data (S250) and collecting additional information from the DASs (S260) are optionally performed as described further below in FIG. 4. It should be noted that caching of enriched data point allows reduced processing resources and power of the CCS, DASs, and traffic between them by eliminating the redundant generation of enriched data points and communication between these components.

In an embodiment, the generated enriched data points may continuously accept new additional information associated with the requested webpage, which are caused to be generated and collected from different DASs. The generated structured data for the webpage is updated to accumulate new information being collected and stored together, for example, in a cache memory and/or database (e.g., the database 150, FIG. 1). As an example, enriched data points may initially only include video analysis. In the same example, two additional analyses of audio analysis and demographic analysis may be collected from two separate DASs, which are added as enriched data points so that the enriched data points for the webpage includes data points from video, audio, and demographic analyses. The accumulation of enriched data points may occur through processing of a single request (by simultaneously sending and collecting data from multiple DASs), over subsequent requests (by collecting new additional information at different times), and any combination thereof. It should be noted that the structured data for the webpage that are stored and retrieved are rich in details by actively and continuously gathering various types of information about the webpage. It should be further appreciated that such cumulative structured data provide a comprehensive description of featured in the webpage that may otherwise be unavailable by, for example, individual crawlers, single DAS, and the like, which do not allow centralized processing, distribution, and collection as disclosed herein.

Building a cache may involve at least one machine learning algorithm applied to the extracted data points and attributes in order to allow caching based on contextual data (or content) rather than based on URL matching. Moreover, URL parameters (or identifiers) that define the webpage may be selected and utilized. The URL parameters include mandatory portions of the URL string without unnecessary or optional portions. To this end, in an example embodiment, cached enriched data points associated with extracted data points may be identified from webpage that may appear in different formats, styles, headers, or the like (e.g., browser page vs. mobile page). The enriched data points may be cached by storing the data points to the cache of the CCS. Further, caching the enriched data points may include caching the enriched data points as structured datasets with a key, association, index, or other, like, data feature, where the data feature is configured to provide for in-cache location of various enriched data points according to the values of the stored data features, such as in a cache search process. In an embodiment, the enriched data points may be cached with a URL that matches the URL of the webpage. It should be noted that enriched data points may have a different cache refresh policy than the extracted data points and/or crawled data.

At S280, the data points determined for the requested webpage are provided to an external entity. The external entity may include, for example, but not limited to, a device, a component, a system, or the like that may utilize the enriched data point to, for example, but not limited to, efficiently identify webpages or contents, make decisions on webpage, and the like, and more. In an embodiment, the enriched data points from a DAS may be propagated to other DAS and/or unrelated external entities to provide additional information on the associated webpage. The external entity (e.g., advertising technology component, user device, external server, and the like, and more) is equipped with accurate and detailed information on the webpage for selecting or discovering webpages based on their needs. In an example embodiment, in a digital advertising environment, the extracted data points and/or attributes are provided together with the enriched data points for the advertiser to make a decision to bid on the respective ad request on the webpage associated with the received data points.

The process described in FIG. 2 describes a method of processing webpage data to obtain further details including extracted data points, attributes, enriched data points and the like. The sophisticated cache memory and/or database including such data for webpages covering the entire web space are utilized to omit performance of one or more of these steps as described in a flow diagram in FIG. 4 herein. The cache memory and/or database may be employed at any point of building such memory when corresponding data is available. That is, the retrieval of data does not require complete, if any, coverage of the whole web space.

FIG. 3 is an example flowchart S240 illustrating a method for processing crawled data of the webpage to extract data points and generate attributes according to one embodiment. It should be noted that the example implementation described herein does not limit the scope of the disclosed embodiments and other implementations to check or not check for cached data at one or more check points may be performed.

The method described herein may be executed by the centralized crawler system (CCS) 120, FIG. 1. In an embodiment, the CCS includes an extraction engine (not shown) to perform the processing of crawled data of the webpage. The crawled data of the webpage may be immediately crawled webpage data (e.g., S230), cached crawled webpage data (e.g., S225), other webpage data stored in a database (e.g., the database 150, FIG. 1), and more. It should be noted that the method is described for a single webpage, but the process may be simultaneously performed for a plurality of webpage data that are crawled or otherwise available at the CCS 120.

At S310, contents of the webpage are identified from the crawled data. The crawled data includes various webpage data such as, but not limited to, a structured layer (or HTML layer), metadata, and the like, and any combination thereof. In an example embodiment, the content may be identified based on the received metadata such as, but not limited to, type of page (e.g., reference type, index type, content type, and more), hierarchical position, domain, language, and more, of the webpage. As an example, paragraphs of texts may be identified as the content for a webpage that is from a specific news domain. The structured layer (or HTML layer) of the crawled data includes, for example, but is not limited to, text, image, hyperlinks, multimedia (e.g., audio, video, etc.). It should be noted that the structure layer includes and represents all parts of the webpage including type of content, but does not include the actual content (i.e., image itself, paragraphs of text, etc.). The structure layer provides parsed tree structure of the webpage, tags, neighbor tags, and the like, and more, which may be utilized to identify contents included on the webpage. In an embodiment,

At S320, the main elements of the webpage are identified from the contents of the webpage by applying at least one algorithm, such as a machine learning algorithm. The main elements are identified as extracted data points of the webpage. A visual layer of the crawled data indicating visual style of webpage and content location may be utilized. The visual layer includes, without limitation, locations of elements, locations of image and/or multimedia, font size, and the like. In a further embodiment, a content structure defining arrangement and description within each identified content that includes, for example, but is not limited to, date, name, structure of articles, menu, navigation parts, and the like, help locate main content within the webpage. Some main elements such as, but not limited to, image, video, audio, multimedia, and the like, may be analyzed to determine data information (e.g., size, length, and the like, and any combination thereof). In an example embodiment, contents or portions of the contents that are not identified as the main elements are not determined as the extracted data points and thus, not stored in association with the webpage. In an embodiment, the extracted data points may be stored in association with the webpage in a cache memory of the CCS and/or the database (e.g., the CCS 120 and the database 150, FIG. 1).

In one embodiment, content extraction algorithms are applied to the crawled data to identify main elements of the webpage. Content extraction algorithms may include various algorithms configured to extract and classify one or more webpage elements, where such algorithms may be further configured to provide high-quality extracted data with low-to-no “noise.” Content extraction algorithms may include various machine learning (ML) algorithms. Content extraction algorithms may be configured to, as an example and without limitation, scan webpages automatically to identify and extract sections and paragraphs based on properties such as text and style, including font, size, color, and the like, as well as in-page location. Further, content extraction algorithms may be configured to generate one or more vector-based representations of a webpage, wherein each webpage element is represented as a vector component. In addition, within the representative vector, each webpage element, represented as a vector component, may include descriptions of webpage element properties or features, the descriptions providing insights regarding the element's role in the webpage, including, as examples and without limitation, font type, font size, font color, in-page location, number of words, number of lines, and the like.

In addition to identifying webpage elements and generating representative vectors thereof, content extraction algorithms may be configured to identify one or more roles for each element. An example of an element role may be “title,” “text,” “comments,” “non-relevant,” and the like. Further, the content extraction algorithm may be configured to include one or more classifier functions or may be configured to prepare analyzed data for classification by such functions. Classifier functions may be configured to provide refined, relevant results (e.g., main elements) in the classification of webpage elements. Such classifier functions may be ML models, or other, like, functions, configured to determine whether a content element matches one or more classifications, where such classifications may be relevant to subsequent data enrichment.

At S330, extracted data points are fed into at least one trained model. The extracted data points indicating the main elements of the webpage are analyzed further by applying the at least one trained model. In an embodiment, the outputs of the at least one trained model are multiple labels for each of the extracted data points. In some embodiments, the at least one trained model may be a multilayer classifier including hidden models for multiple labels for the extracted data points. In an example embodiment, a multi-label output of an extracted data is a vector representation of probabilities of each label. As an example, an extracted data point of the main text of the webpage is input into at least one trained model to determine probabilities for certain topics, for example, sports, news, marketing, culture, and the like, and probabilities for certain languages such as, English, French, Spanish, Chinses, and the like. In a further embodiment, a threshold value is used in each label to determine and output at least one label for the input extracted data point.

In a further embodiment, the extracted data points may be analyzed to determine, for example, but not limited to, safety levels, structural categories, and the like, and any combination thereof. The safety level of the extracted data points may be determined for various safety concerns such as sensitive content, gambling, foul language, smoking, and more. The structural categories may define, for example, type visual data (e.g., image, video, audio, and more), social medial content, a customer review, and the like, and more. In an example embodiment, one or more extracted data points that are identified as a common label, for example common structural category, may be grouped and stored together.

In some embodiments, the at least one trained model may apply a hierarchical classification algorithm to the extracted data points in order to accurately determine labels for the webpage. That is, varied probability and/or threshold for a second classification may be utilized depending on a first classification label. As an example, a binary (yes/no) second classification on age appropriateness (i.e., safety level) may be determined for a webpage. In this case, the threshold value for classifying the webpage as age appropriate may be higher in a first webpage describing picture books than a second webpage describing politics. As another example, a second classification for a webpage including and describing a term “Amazon” may be different when the webpage is labeled to describe topics on “geography” compared to “technology.” In this example, the webpage may be labeled with “environment” and “e-commerce,” respectively, through second classification.

At S340, attributes of the webpage are generated based on outputs of the at least one trained model. In an embodiment, the attributes may include a plurality of labels determined for the extracted data points that are associated with the webpage. The attributes provide additional descriptions and characteristics about the content and context of the webpage that may be one or more extracted data points indicating the main elements. It should be appreciated that the generated attributes are not apparent in the data that are simply crawled from the webpage without processing of the crawled data. In an embodiment, the attributes of the webpage may include, for example, but not limited to, content type, language, topic, sentiment, safety information, domain information (e.g., high traffic, etc.), and the like, and any combination thereof. The process continues to S250, FIG. 2.

In an embodiment, the extracted data points and the generated attributes are associated with the webpage and cached as discussed in FIG. 2. The attributes and the extracted data points such as, image, text, video, audio, and the like, of the webpage may be stored as structured datasets in a cache memory of a CCS, a memory, and/or a database (e.g., the CCS 120 and the database 150, FIG. 1).

In some embodiments, steps S320 and S330 may be optionally performed. In some other embodiments, a machine learning model may be applied to the webpage data (e.g., crawled, cached, otherwise available, etc.) to output extracted data points and/or attributes that are stored in a cache and/or database thereafter. The model applied for extracting data points may be externally obtained, developed in house, or any combination thereof.

It should be noted that the method of generating attributes for webpages based on content extraction and understanding is automatically performed without any manual intervention. The method applies at least one algorithm that accurately and efficiently discovers the main elements and further, generates attributes for webpage in near real-time. Thus, the processing of crawled data described herein cannot be performed manually.

FIG. 4 is an example flow diagram 400 illustrating a process of utilizing a centralized crawler system (CCS) to distribute enriched data points of a webpage according to one example implementation. It should be noted that the example implementation described herein does not limit the scope of the disclosed embodiments and other implementations to check or not check for cached data at one or more check points may be performed.

At 401, a webpage data is requested. The webpage data to request may be selected based on a plurality of rules, for example, as described in S210, FIG. 2.

At 402, it is checked if there are cached crawled data of the requested webpage. The crawled data are webpage data including, for example, but not limited to, a structured layer (or HTML layer), metadata, and the like, and any combination thereof. If so, at 450, the crawled data is retrieved from the cache.

Otherwise, if the cached crawled data is not available, the operation continues to 403 to crawl data for the requested webpage data. The operation continues using the crawled data. At 404, the crawled data (i.e., webpage data) is processed for extracted data points. At 405, the extracted data points are sent to, for example, one or more data analysis systems (DASs) and enriched data points are generated for the requested webpage data. At 406, at least one of the extracted data points, the attributes, and the enriched data points of the requested webpage data is distributed to an external entity. The external entity is, for example, user, server, system, and the like, and any combination thereof, that such data for various decisions. The operations of 402 through 406 are performed as described in, for example, steps S240 through S280 of FIG. 2 above. The operation at 405 may include steps S250 through S270 of FIG. 2. The data obtained at each operation from 403 through 405 may be stored in a cache for future retrieval and/or processing.

It should be noted that the process is described with respect to a cache; however, the stored data may be retrieved from any one of a cache memory, a memory, a database (e.g., the database 150, FIG. 1), and the like, that is associated with the CCS.

As noted above, if cached crawled data is available, the crawled data is retrieved at 450. At 451, it is checked if there are cached extracted data points for the requested webpage data. If not, the execution continues with 404 for processing, followed by 405 and 406. If so, at 452, the cached extracted data points are retrieved.

At 453, it is checked if there are cached enriched data points for the requested webpage data. If not, the execution continues with 405 for sending and generating enriched data points, followed by 406. If so, at 454, the enriched data points are retrieved. The operation may continue to 406 to distribute the retrieved enriched data points to an external entity.

At 455, optionally, it is checked if the enriched data points are for a certain type of data (e.g., image, audio, text, video, etc.). If not, the execution continues with 405 for generating enriched data points of the certain type of data, followed by 406. If so, the execution continues with 406 to distribute the enriched data points that were retrieved at 454 to an external entity. The certain type of data may be predefined by, for example, an external entity, the CCS, and the like, and any combination thereof.

Steps to check cached enriched data points at 453 and 455 may occur simultaneously or consecutively, to determine whether enriched data points of the certain type or for certain extracted data points exists in the cache. As for the two-step procedure, the operation continues with 405 upon determination that cached data does not exist (e.g., no cached enriched data, no cached enriched data of the certain type, etc.), and operation continues with 406 to distribute the enriched data upon determination and retrieval of enriched data.

In an example embodiment, the certain type of enriched data points may be predefined by a demand of the external entity that is to receive and utilize the enriched data points distributed by the CCS. As an example, a first entity may demand enriched data points for images in a webpage. When the cache and/or memory only includes enriched data points for texts of the requested webpage, new enriched data points for images of the requested webpage are generated by utilizing DASs that perform image analyses (405). In another example embodiment, the certain type of enriched data points to check may be determined by the DASs available for the CCS to cause generation of additional details for enriched data points. As an example, a second type of enriched data points may be checked for when a second DAS that provides a new type of analysis is connected to a CCS.

The new enriched data points are added to the dataset of the requested webpage data that includes, for example, but not limited to, crawled data, extracted data points, attributes, enriched data points, and the like, and any combination thereof. It should be noted that new enriched data points may be continuously added with different analyses being performed and collected. That is, the dataset of the requested webpage becomes more and more rich in information about the webpage as enriched data points analyzed using different DASs are compiled.

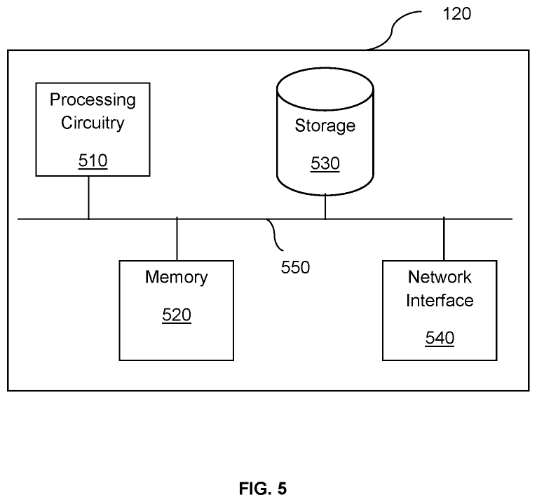

FIG. 5 is an example schematic diagram of a centralized crawler system (CCS) 120, according to an embodiment. The CCS 120 includes a processing circuitry 510 coupled to a memory 520, a storage 530, and a network interface 540. In an embodiment, the components of the CCS 120 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

In an embodiment, the memory 520 servers as a cache memory to cache data points (enriched or extracted). The storage 530 may be magnetic storage, optical storage, and the like, and may be realized, for example, as flash memory or another memory technology, compact disk-read only memory (CD-ROM), Digital Versatile Disks (DVDs), or any other medium which can be used to store the desired information.

The network interface 540 allows the CCS 120 to communicate with the various components, devices, and systems described herein for enriching ad requests for real-time bidding, as well as other, like, purposes.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Further, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for centralized crawling and extracting data points of a webpage using a centralized crawler system, comprising:
crawling requested webpage data, wherein the requested webpage data is selected based on a plurality of rules and includes a hypertext markup language (HTML) layer and metadata of a requested webpage;
extracting at least one data point that indicate a main element that describes contents of the requested webpage;
generating at least one enriched data point that provides additional information on the at least one extracted data point, wherein the additional information is collected from a plurality of data analysis systems (DASs); and
creating a structured dataset of the requested webpage data based on the at least one extracted data point.

2. The method of claim 1, further comprising:
providing the at least one enriched data point of the webpage to an external entity.

3. The method of claim 1, further comprising:
distributing a subset of the at least one extracted data point to a first DAS of the plurality of DASs, wherein the subset of the at least one extracted data point is determined based on a first filtering rule of the first DAS; and
causing generation of the additional information on the subset of the at least one extracted data point.

4. The method of claim 1, further comprising:
storing a cache for the requested webpage, wherein the cache includes at least one of: the webpage data, the at least one extracted data point, at least one attribute, the at least one enriched data point, and the structured dataset.

5. The method of claim 4, wherein the attribute is at least one of: content type, topic, language, sentiment, safety information, and domain information.

6. The method of claim 4, further comprising:
subsequently selecting to request the requested webpage data; and
retrieving portions of the structured dataset from the cache.

7. The method of claim 4, wherein the at least one enriched data point is at least one first enriched data point, further comprising:
distributing a second subset of the at least one extracted data point to a second DAS of the plurality of DASs, wherein the second subset of the at least one extracted data point is determined based on a second filtering rule of the second DAS; and
generating at least one second enriched data point collected from the second DAS, wherein the second DAS is caused to generate the at least one second enriched data point; and
adding the at least one second enriched data point to the structured dataset and the cache of the requested webpage.

8. The method of claim 1, wherein the plurality of rules is defined by at least one of:
a user demand, a web server, each DAS of the plurality of DASs, a schedule, a domain, and a network traffic.

9. The method of claim 1, wherein extracting the at least one data point further comprises:
identifying contents of the requested webpage from the crawled webpage data;
applying an algorithm to identify at least one main element and at least one attribute, wherein the at least one main element is identified as the at least one extracted data point; and
generating the at least one attribute by classifying the at least one main element.

10. A non-transitory computer readable medium having stored thereon instructions for causing a processing circuitry to execute a process, the process comprising:
crawling requested webpage data, wherein the requested webpage data is selected based on a plurality of rules and includes a hypertext markup language (HTML) layer and metadata of a requested webpage;
extracting at least one data point that indicate a main element that describes contents of the requested webpage;
generating at least one enriched data point that provides additional information on the at least one extracted data point, wherein the additional information is collected from a plurality of data analysis systems (DASs); and
creating a structured dataset of the requested webpage data based on the at least one extracted data point.

11. A system for centralized crawling and extracting data points of a webpage using a centralized crawler system, comprising:
a processing circuitry; and
a memory, the memory containing instructions that, when executed by the processing circuitry, configure the system to:
crawl requested webpage data, wherein the requested webpage data is selected based on a plurality of rules and includes a hypertext markup language (HTML) layer and metadata of a requested webpage;
extract at least one data point that indicate a main element that describes contents of the requested webpage;
generate at least one enriched data point that provides additional information on the at least one extracted data point, wherein the additional information is collected from a plurality of data analysis systems (DASs); and
create a structured dataset of the requested webpage data based on the at least one extracted data point.

12. The system of claim 11, wherein the system is further configured to:
provide the at least one enriched data point of the webpage to an external entity.

13. The system of claim 11, wherein the system is further configured to:
distribute a subset of the at least one extracted data point to a first DAS of the plurality of DASs, wherein the subset of the at least one extracted data point is determined based on a first filtering rule of the first DAS; and
cause generation of the additional information on the subset of the at least one extracted data point.

14. The system of claim 11, wherein the system is further configured to:
store a cache for the requested webpage, wherein the cache includes at least one of: the webpage data, the at least one extracted data point, at least one attribute, the at least one enriched data point, and the structured dataset.

15. The system of claim 14, wherein the attribute is at least one of: content type, topic, language, sentiment, safety information, and domain information.

16. The system of claim 14, wherein the system is further configured to:
subsequently select to request the requested webpage data; and
retrieve portions of the structured dataset from the cache.

17. The system of claim 14, wherein the at least one enriched data point is at least one first enriched data point, wherein the system is further configured to:
distribute a second subset of the at least one extracted data point to a second DAS of the plurality of DASs, wherein the second subset of the at least one extracted data point is determined based on a second filtering rule of the second DAS; and
generate at least one second enriched data point collected from the second DAS, wherein the second DAS is caused to generate the at least one second enriched data point; and
add the at least one second enriched data point to the structured dataset and the cache of the requested webpage.

18. The system of claim 11, wherein the plurality of rules is defined by at least one of:
a user demand, a web server, each DAS of the plurality of DASs, a schedule, a domain, and a network traffic.

19. The system of claim 11, wherein the system is further configured to:
identify contents of the requested webpage from the crawled webpage data;
apply an algorithm to identify at least one main element and at least one attribute, wherein the at least one main element is identified as the at least one extracted data point; and
generate the at least one attribute by classifying the at least one main element.
